(19) United States
(12) Patent Application Publication
(10) Pub. No.: US 2008/0163284 A1
(43) Pub. Date: Jul. 3, 2008

(54) Browse filters on a television interface

(75) Inventors: Gregory A. Martinez, Seattle, WA (US); Steven R. Gunn, Bellevue, WA (US); Paolo V. Malabuyo, Bothell, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/647,762

(22) Filed: Dec. 29, 2006

(51) Int. Cl. H04N 7/16

(52) U.S. Cl. 725/25

(57) ABSTRACT

Described are a system and a corresponding user interface that couple to a media service to provide browse-filtered access to media content, in a manner that facilitates location and/or selection of a particular content item. For example, filtering categories (e.g., new arrivals, genre, and so forth) are listed vertically for navigation and selection in one column, with representations of available content (e.g., top downloads) listed vertically in another column. Queries corresponding to a home page menu as controllable via user input provide the listed items, whereby the user may navigate and select content and filtered submenus via a simplified user interface input mechanism, such as a D-Pad or the like. One filtering category may include a ratings-based category, in which a user is matched to content items based upon ratings provided by at least one ratings source affiliated with the service (a friends list).

### BACKGROUND

Various types of television set top boxes allow users to browse among lists of displayed items and make selections. For example, via a set top box, a viewer can access an online video store that offers large amounts of content that can be viewed on a television set, such as movies and television shows, with more and more content regularly becoming available. Similarly, a user can access such listed items via mobile phones and other devices such as personal media players that are equipped to download and show content.

However, unlike a computer system that has a mouse, a keyboard and searching and sorting capabilities, a set-top box interface or small device interface offers limited interaction options, typically a directional pad (D-Pad) or the like comprising a four-directional navigation and selection mechanisms. For example, in past television interface designs, the user has needed to go down several levels to find items for viewing and/or purchasing. For example, a user looking for a specific item may use an alphabetical view, select a starting letter such as through a displayed virtual keyboard, and then look for that specific item within a possibly very long list containing hundreds or even thousands of items. This is frequently very time consuming and/or frustrating for a user, and may cause the user to abort a search for an item, and consequently not find or purchase that item.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a system and user interface that couples to an Internet service that provides browse-filtered access to content, in which selectable representations of filtering categories are listed vertically for navigation, and selectable representations of available content are separately (e.g., in another column) listed vertically for navigation. For example, one filtering category may, when selected, provide access to listed items of new arrivals; the selectable representations of available content may provide access to top (most popular) downloads, e.g., within a time window such as the last two weeks, last day, or other suitable time frame.

In one example implementation, the user navigates via a user interface input mechanism comprising left, right up and down directional sensors and a selection mechanism. A query component queries the service for a filtered list of items to display, such as including top download items. In this example, user selection of a top download provides access to that content for purchasing or the like, e.g., directly, without having to navigate among sub-selections of other content. User selection of a filtering category corresponds to a further filtering query, e.g., a query for new arrival items, for items corresponding to content in theaters, movies, clips, genres, rated items, networks, or television shows, or any combination thereof. Items of content are then displayed based upon the query results. One filtering category may include a ratings-based category, in which a user is matched to content items based upon ratings provided by at least one ratings source affiliated with the service (a list of buddies that also use the service).

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example block diagram of a general-purpose environment including an example set-top box and television into which various aspects of the present invention may be incorporated.

FIG. 2 is a representation of components within an example set top box to provide filtering queries that locate more narrowed subsets of items for display to facilitate user finding and selection of an item.

FIG. 3 is a representation of an example user interface that facilitates the user's finding and/or selection of a particular movie.

FIG. 4 is a representation of an example user interface that facilitates the user's finding and/or selection of a particular television show.

### DETAILED DESCRIPTION

Various aspects of the technology described herein are generally directed towards a filter mechanism used with a television interface that provides more direct accessibility to specific items that typical users are likely trying to find or select (such as to purchase). In general, such items correspond to “short cuts” to certain items, particularly items that are likely of interest to a large portion of a base of users that interact via such interfaces. For example, items that are likely of interest to many users include new arrivals to an online video service, and top user downloads. Also, each user may have items located according to that particular user's tastes in content, such as by matching up that user with similar users, e.g., a list of friends, to provide rapid access to items rated highly by those similar users.

Although one implementation exemplified herein generally describes a set-top box implementation controlled via an interface having a D-Pad-enabled remote control device, such as a game console, a cable box, a satellite receiver, a media extender, a television-based web browser, a digital media receiver, a computer system's auxiliary device, a personal video recorder and so forth, the concepts are not limited to any particular device or interface. For example, a mobile phone, a personal video/media viewing device, and even a television itself without a set top box (but possibly with a cablecard or the like) can benefit from the technology described herein. Moreover, any suitable interface may be used, including buttons physically coupled to a device, or buttons on a remote control indirectly coupled to a device such as via a wire, infrared or radio frequency signals, such as found on a media-related remote control or video game controller.

Further, while described examples include navigation and selection of movies and television content, these are only examples, and there is no limitation as to any particular type of content that may be presented to a user. For example, other types of media content may include audio content such as music (songs or narrated audio books), user-generated videos, music videos, and/or game related content.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in television-based browsing and/or browsing with a limited user interface in general.

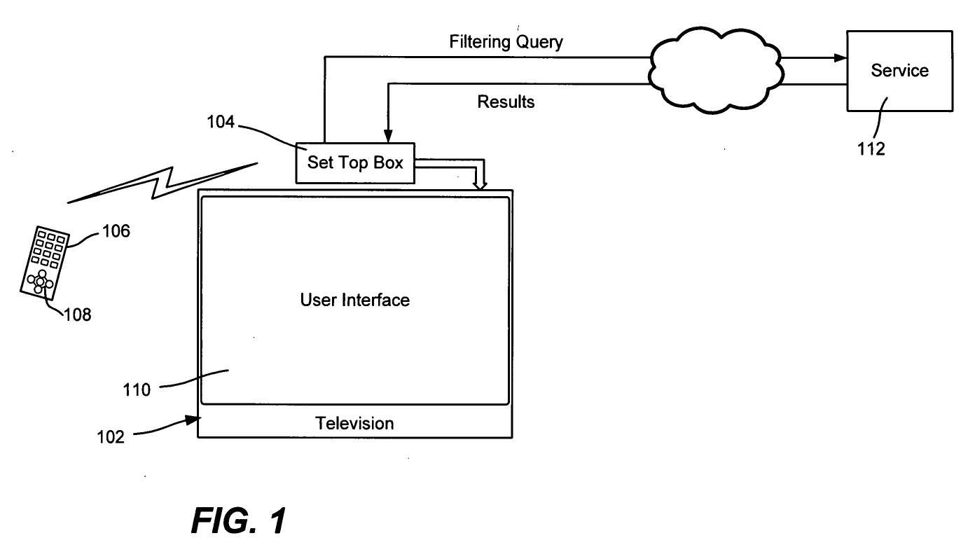

Turning to FIG. 1, there is shown a media player in the example form of a television set 102 coupled to a set top box 104. The set top box 104 is controlled via a wireless (or alternatively wired) remote control 106, which may be a conventional remote control, for example that changes channels, adjusts volume and so forth, may be a game controller, or may be some other type of controller. In FIG. 1, the remote control 106 is shown as having buttons and a D-Pad 108, with a select switch in the center of directional buttons. As can be readily appreciated, the select switch can be located elsewhere, and indeed, the select switch may correspond to the “A” button on a game controller, for example. Note that in a single-column user interface having multiple rows, only up and down and selection navigation mechanisms may be present (or equivalently left and right and selection navigation mechanisms in a single row, multiple column user interface).

In general, the user interacts with the set top box according to a user interface 110 displayed on the television set 102. Note that FIG. 1 is only for example descriptive purposes, as a set top box is not required, but instead can have its logic and other circuitry integrated into the television or the like, or into of another device. Similarly, a television set is not required as the media player, but may be any device capable of displaying a user interface, such as a monitor, mobile phone's display screen and so forth.

Also represented in FIG. 1 is a service 112 that provides lists of items for display on the user interface. The set top box 104 is shown as coupling to the service 112 through some communication means, such as via a network connection, ordinarily the Internet. Intermediate networking components such as a modem, router, switch, hub, other computer system and so forth are not shown for purposes of simplicity, but may be present in a given system.

In general, using the technology described herein, the set top box 104 outputs lists of items to the user interface 110 by querying the service 112 for a reasonably small subset of all available items. For example, the service 112 may have thousands of items, but the set top box 104 will request only fifty at a time, due to limited resources. Some or all of the subset of items may be displayed at one time. If additional items are needed as a user scrolls beyond a certain item, for example, another query is made for the next subset of items, and so forth.

In past systems, the queries were linear in nature, retrieving the next subset of all relevant items as the user scrolled down, for example. Note that with server-side queries or paging through server-side contents, there are a number of issues that need to be handled, such as the querying device may not have enough memory to hold the entire list of contents returned, and/or that the set top box may not know how many pages of data the server has. With the technology described herein in which the querying entity (e.g., the set top box) is instead capable of making filtering queries to obtain a filtered subset of the available items, some of the server-side querying issues are handled by controlling (to an extent) the amount of contents that are to be returned.

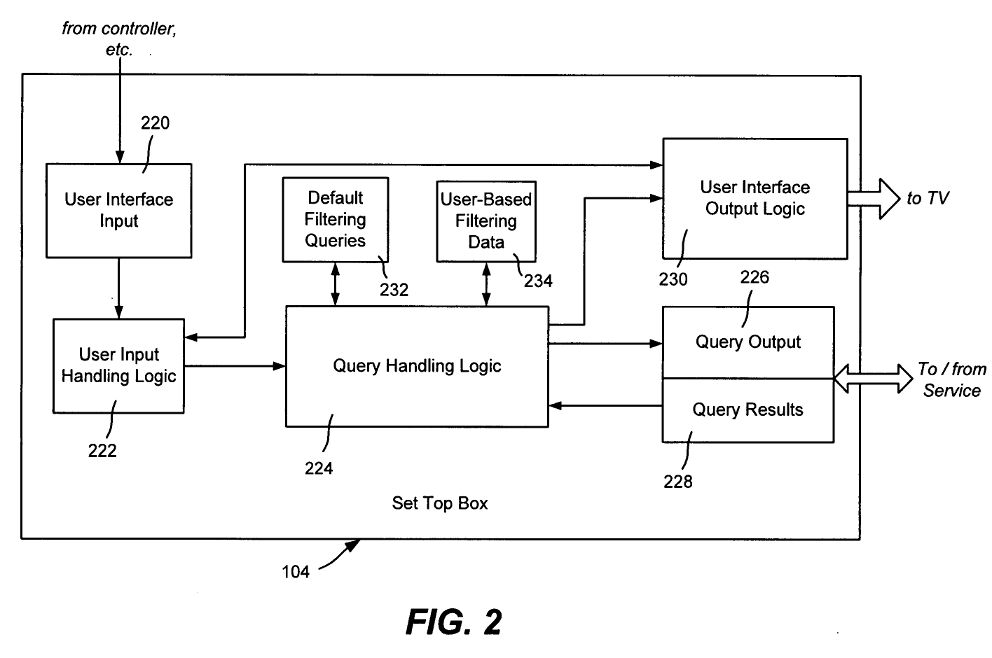

FIG. 2 is a representation of logical components that facilitate the transmission and handling of filtering queries. In this example, as the user interface input 220 is received from the controller (e.g., a remote control for the set-top box), user input handling logic 222 determines that the user is requesting a page be displayed with items that correspond at least in part to a filtering query. Query handling logic 224 is thus triggered, and an appropriate query 226 sent to the service 112. Some or all of the returned query results 228 are then output to the television via user interface output logic 230. For example, the selected page may trigger a query that requests the top (most popular) downloads as previously requested by other users of the service.

Thus, based on the user input, the query handling logic 224 may send one of a number of default queries 232, such as to return the new arrivals, and/or to return the top downloads (the most frequently requested by other users, e.g., within the last day). For example, the “new arrivals” query may be requesting fifty movie titles, starting with those most recently added to the service (e.g., in the last two weeks), but not more than two years old (e.g., since released); if less than fifty titles meet that criteria, then the limiting dates may change to achieve the minimum of fifty. For television shows, the “new arrivals” query may be the most recent two weeks of episodes based on the original air date. Network shows, syndicated shows and other limiting factors may be used as criteria provided with the query.

In one example implementation, the queries are limited to those most likely of value to the greatest number of users. However, some user-based filtering data 234 may be maintained by the set-top box 104. For example, an identifier that can be used for billing purposes typically already exists, whereby that identifier or a similar one may be matched to a “buddy list” kept at the service 112. Via a filtering query that provides the identifier, the user may thus obtain a list of content items that were highly rated by those on that particular user's buddy list. Alternatives for providing likely-desirable content matched to a specific user/identifier may include content based on the evaluations of a ratings service, based on the preferences of one or more professional reviewers appreciated by that user, and so forth.

Although not necessary, other user-based filtering data 234 may be maintained, including user preferences and/or queries customized for a user. For example, one user may want the top ten downloads, while another may want the top twenty. One user may want the top twenty action movies, a different user may want the top twenty comedies. A user may set such preferences via a subsection of the user interface 110, or possibly by another means, such as by interacting with the service 112 (or another service) via a personal computer.

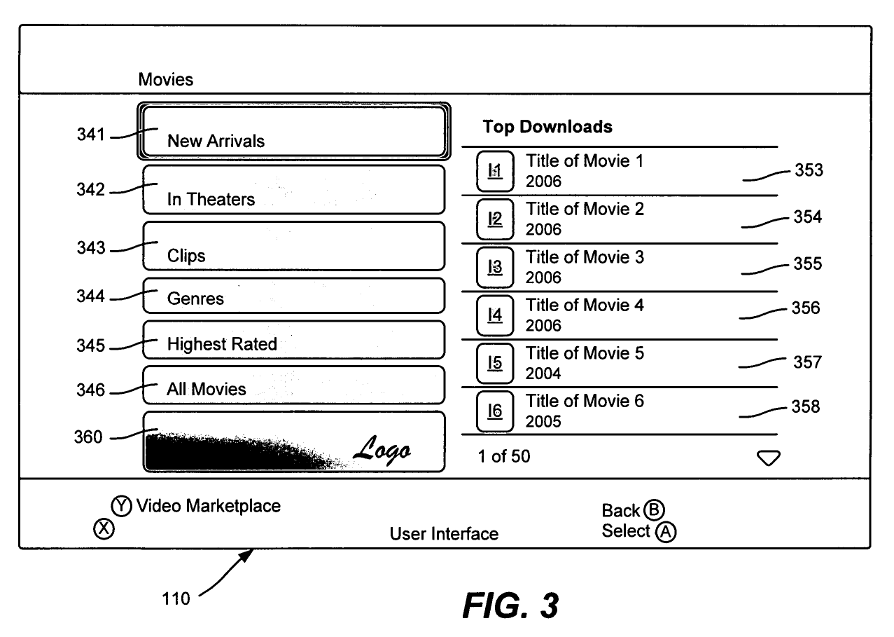

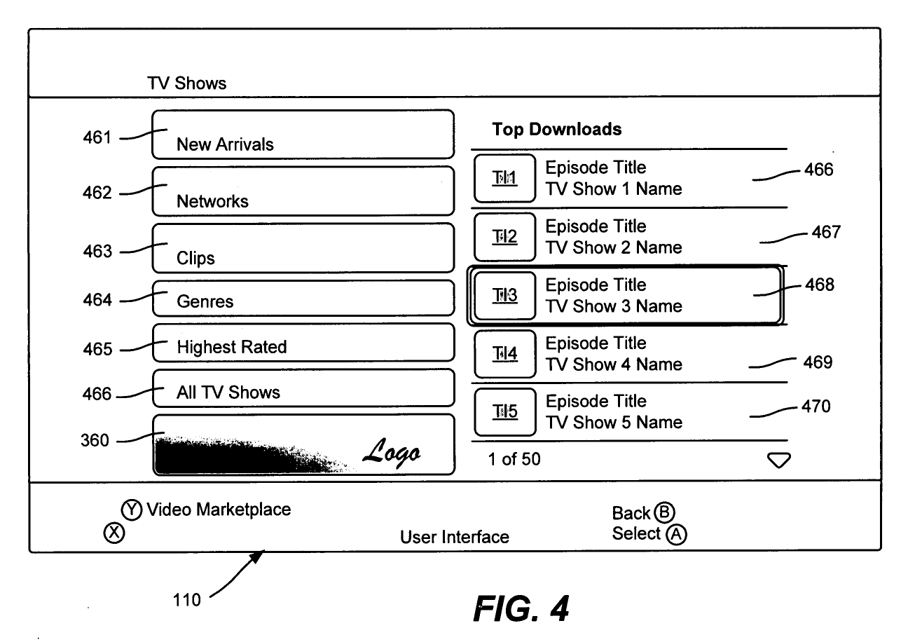

Thus, the browse filters reduce time and frustration for users in finding particular content that each would like to locate or purchase. Examples shown in FIGS. 3 and 4 include “New Arrivals” and “Top Downloads,” with others such as “Highest Rated” (e.g., by friends), genres, clips, theaters (FIG. 3) networks (FIG. 4) also shown. A logo 360 or the like, along with clues for which button to press, are also shown for completeness.

As can be readily understood, the provision of browse filters provides significantly more immediate accessibility to items that a user would like to find or purchase. This is generally facilitated via “short cuts” to content on the service, which provide views that dramatically reduce browse times for large segments of the user base.

By way of example, FIG. 3 shows a movie-related browse page including new arrivals 341 (along with other filtering categories 342-345 and an unfiltered “All” category 346) one selection click away. Top downloads are individually shown to the right in this example interface. Selection of a filtering category takes the browser to a sup-page that displays the selected items, or possibly to another part of the page, such as a pop-up selection window, or changing the right half of the display. In any alternative, the example design thus provides a feature that focuses on usability via viewing categories such as new arrivals to the service, which provides the ability to avoid lengthy browsing of content (such as via an alphabetical view) to find a specific item that a user may be interested in purchasing. The inclusion of new arrivals and other filtering categories, each as a browse-able list, provides users a quick way to find items that may be highly desirable for viewing or purchasing.

In one example implementation of the service, the “New Arrivals” category has been implemented in a way that further enhances accessibility, by tending to maximize the relevancy of included items. To this end, the new items to the service (in this example a video store) that are under a period of time defined as relevant (e.g., new movies under two years from release) are included in the New Arrivals filtered list. Additionally, items that have been available to the service (less than two weeks in this case) are presented to the user. Further, in this example implementation, items are presented with the most recent item first. The exemplified television page of FIG. 4 provide similar filtering categories 461-466, including a new arrivals category 461, which may user different factors as to what is considered new (e.g., based on original air date and date it became available to the service).

A combined effect of these concepts attempts to maximize the usability of content presentation and increase the likelihood that a user will view or purchase an item. For example, users only see new releases that are available on the service (e.g., newer movies) and not old episodes of obscure content that are not likely to generate significant purchase volume.

The examples of FIGS. 3 and 4 also demonstrate the concept of items for top move and television episode downloads 353-358 or 466-470, respectively, which in this example are shown directly at the main menu page. Movie icons I1-I5 or television icons TI1-TI5 are shown as providing an image to a user to help guide in making a selection, although other features such as a video preview may be shown. In the examples of FIGS. 3 and 4, the design provides a scroll-able list of the top downloaded items; fifty are exemplified in one design, but any practical number may be implemented, and the number possibly may be user-configurable. In general, this aspect provides enhanced accessibility by elevating items that other users currently find highly desirable.

In one aspect, the top downloads are kept fresh by locking to a small window of time, e.g., one day in one current design, but possibly a different time frame such as within the last one to two weeks. Items that are heavily downloaded by the user base are more likely to be found interesting by other users looking for a specific item, and the order in which top downloads items are displayed may be arranged based on popularity.

Another way that adds usability may include presenting content items 345 or 465 rated by friends from a ‘friend’ or ‘buddy’ list, or similar ratings service. This list of items presents items that are likely desirable to a given user because they have been rated highly by friends, and a correlation should exists between a user's tastes and a user friend's tastes in content. The reviews of a user's preferred reviewers and critics may be an alternative source of filtering criteria.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A system that couples to a service that provides access to content, the system comprising:
a user interface input mechanism comprising up and down directional sensors and a selection mechanism;
a query component that queries the service for a filtered list of items to display, including top download items or new arrival items, or both top download items and new arrival items; and
a user interface output component that displays at least some of the filtered list of items in rows for selection of an item via user interaction with the user interface input mechanism, the user interaction including navigation commands entered at the up and down directional sensors and a selection command entered via the selection mechanism.

2. The system of claim 1 wherein the filtered list of items is displayed on a television set.

3. The system of claim 1 wherein the query component is incorporated into a set top box.

4. The system of claim 1 wherein the service provides one or more lists of movies, one or more lists of television shows, one or more lists of user-generated videos, one or more lists of music videos, one or more lists of game-related content, or one or more lists of audio content, or any combination of one or more lists of movies, one or more lists of television shows, one or more lists of user-generated videos, one or more lists of music videos, one or more lists of game-related content, or one or more lists of audio content.

5. The system of claim 1 wherein the user interface input mechanism further comprises left and right directional sensors, and wherein the user interface output component arranges at least some of its output in columns such that the user interaction navigates among columns via commands entered at the left and right directional sensors.

6. The system of claim 5 wherein the user interface output component displays filtering categories in one column and at least some of the top downloads in another column.

7. The system of claim 6 wherein the filtering categories are displayed in a first column that is to the left of a second column in which at least some of the top downloads are displayed.

8. The system of claim 6 wherein the filtering categories include at least one element of a set, the set containing: new arrivals, in theaters, all movies, clips, genres, rated items, networks, or all television shows, or any combination thereof.

9. In a media environment in which media content obtained from a service may be presented on a device, a user interface, comprising:
selectable representations of filtering categories listed vertically for navigation, each represented filtering category when selected providing access to a corresponding subset of media content available via the service; and
selectable representations of available content presented separately from the selectable filtering categories and listed vertically for navigation, each representation of content when selected providing access to that content without requiring further sub-selection among other selectable content.

10. The user interface of claim 9 wherein the selection of a filtering category corresponds to a query that queries the service for a specific subset of items to display.

11. The user interface of claim 9 wherein the selectable representations of available content correspond to top downloads within a specific time window.

12. The user interface of claim 9 wherein the service provides one or more lists of movies, one or more lists of television shows, one or more lists of user-generated videos, one or more lists of music videos, one or more lists of game-related content, or one or more lists of audio content, or any combination of one or more lists of movies, one or more lists of television shows, one or more lists of user-generated videos, one or more lists of music videos, one or more lists of game-related content, or one or more lists of audio content.

13. The user interface of claim 9 wherein the user interface is navigated via an input mechanism having left, right, up and down directional sensors, and wherein selection is made via a selection mechanism of the input mechanism.

14. The user interface of claim 9 wherein the user interface displays the selectable representations of filtering categories in one column, displays the selectable representations of available content in another column, and wherein at least one of the columns is arranged for scrolling.

15. The user interface of claim 9 wherein the selectable representations of filtering categories include at least one element of a set, the set containing: new arrivals, in theaters, all movies, clips, genres, rated items, networks, or all television shows, or any combination thereof.

16. In a media environment, a user interface system, comprising:
an input mechanism having directional navigation sensors and a selection mechanism; and
an output mechanism that outputs a display comprising:
a list of filtering categories listed vertically in one column for navigation, each filtering category capable of being selected, and when selected providing access to a corresponding subset of media content; and
representations of available content listed vertically in another column for navigation, each representation of available content capable of being selected, and when selected providing access to corresponding media content without requiring further sub-selection among other selectable content.

17. The user interface system of claim 16 wherein the directional navigation sensors comprises a generally oval or circular combination switch having up, down, left and right sensors.

18. The user interface system of claim 16 wherein the representations of filtering categories include new arrivals to a service, and wherein the representations of available content correspond to top downloads from the service within a specific time window.

19. The user interface system of claim 18 wherein the new arrivals to the service contain items each deemed new based on a release date of the item and a date when the item became available from the service.

20. The user interface system of claim 16 wherein the representations of filtering categories include a ratings-based category corresponding to an identifier corresponding to that user interface, the identifier used to match a query for content items to a service to content based on ratings provided by at least one ratings source affiliated with the service.
